(19) United States
(12) Patent Application Publication
(10) Pub. No.: US 2022/0292979 A1
(43) Pub. Date: Sep. 15, 2022

(54) SYSTEM AND METHOD OF REQUESTING WASTE COLLECTION SERVICES USING AUTOMATED DISPATCH AND INTERROGATION

(71) Applicant: Ecube Labs Co., LTD., Monterey Park, CA (US)

(72) Inventor: Sunbeom Gwon, Seoul (KR)

(21) Appl. No.: 17/755,026

(22) PCT Filed: Oct. 21, 2020
(86) PCT No.: PCT/US2020/056561

§ 371 Date: Apr. 19, 2022

Related U.S. Application Data
(60) Provisional application No. 62/923,846, filed on Oct. 21, 2019.

(51) Int. Cl. G08G 1/00; G06Q 10/00; B65F 1/14; G08G 1/0968

(52) U.S. Cl. CPC G08G 1/202; G08G 1/22; G06Q 10/30; B65F 1/14; G08G 1/096844; B65F 2210/128

(57) ABSTRACT

A system for efficiently and automatically requesting waste collection services through the use of mobile communication devices is disclosed. The system utilizes a fill-level sensor or fill-level sensors attached to dumpsters of various sizes. The fill-level sensor is configured to monitor a dumpster's capacity in terms of waste volume. Whenever the volume reaches a predetermined fill-level set by the generator, an automatic collection request is sent out to at least one hauler capable of carrying out the collection.

### CROSS-REFERENCE TO RELATED APPLICATIONS

This application claims the benefit of U.S. Provisional Patent Application No. 62/923,846 filed Oct. 21, 2019, the disclosure of which is hereby incorporated by reference as if fully set-forth in its respective entirety herein, for all purposes.

### BACKGROUND OF THE PRESENT DISCLOSURE

Waste disposal and collection is an important part of waste management. Embodiments of the present disclosure relate to waste management, and more specifically, to a system for optimized waste collection.

### SUMMARY OF THE PRESENT DISCLOSURE

The present disclosure provides methods, systems, and computer program products for waste management. A system is disclosed for managing collection by a waste hauler of waste generated by a waste generator at a waste generator site. The system includes a user interface, a platform system functionally connected to the user interface, a fleet management system functionally connected to the platform system, a waste container at the waste generator site, a sensing device operative to sense a fill-level of the waste container. The user interface may be operable by a user (e.g., customer or system administrator) to allow the waste hauler to connect to the platform system and to the fleet management system to arrange a waste collection at the waste generator site based at least on the sensing device at the waste generator site indicating a fill-level of the waste container is equal to or more than a predetermined waste level.

The user interface may include a mobile device application. The mobile device application may be functionally connected to the platform system. The fleet management system may include a server that stores information and a fleet management process. The user interface may be operable to allow the waste hauler to transmit information to the platform system to create an account for the information being stored in the platform system. The platform system may then send the information to the fleet management system and the fleet management system stores the information. The fleet management system may be maintained as a separate system in the system module. The fleet management system may send a signal back to the platform system indicating that the waste hauler is registered. The user interface may be operable to allow the waste generator to sign up for a waste collection service via the controller system, and the platform system automatically assigns the sensing device to a service account associated with the waste generator.

The sensing device may include a fill-level sensor that is physically installed inside of the waste container. The sensor is configured to transmit a plurality of data including the waste container's latitude and longitude, which specifies an exact location of the waste container, which is stored in the fleet management system. The plurality of data may be transmitted wirelessly. The user interface may be operable by the waste hauler to indicate to the platform system an intention to perform the waste collection, the platform system functionally connects to the fleet management system, and the fleet management system generates a route from the waste hauler's current location to the waste container's location. The route may be most optimal route for location based on at least one of the following factors: the waste hauler's current location, the waste container's location, location of other waste container collection tasks, traffic, urgency of the collection task, and the like. The route may be displayed on the user interface. The current location of the waste hauler may also be displayed on the user interface in relation to the waste container's location. The current location of the waste hauler may be updated on the user interface at discrete intervals. In an embodiment of the present disclosure, the waste container may include a dumpster. After the waste collection is complete, the waste hauler may use the user interface to transmit information to the platform system selected from the group consisting of: a volume of the collected waste, a weight of the collected waste, a comment specific to the waste collection, and a photo to provide verification that the waste collection has occurred.

When the fleet management system deems a waste collection completed, the fleet management system may stay connected to the user interface. The platform system may be configured to send a notification back to the waste hauler via the user interface to acknowledge the waste collection has occurred. The platform system may then transmit a confirmation notification to the waste generator acknowledging the waste collection has been completed. Once the confirmation notification has been transmitted, both the waste generator and the waste hauler may use the user interface to review a plurality of details regarding the waste collection.

### DESCRIPTION OF THE DRAWINGS

FIG. 1 illustrates an example of a process for requesting waste collection services according to embodiments of the present disclosure.

FIG. 2A an example diagram of a computer/processing device wherein one or more of the techniques of the disclosure may be implemented.

FIG. 2B is an example diagram of a computer/processing device wherein one or more of the techniques of the disclosure may be implemented.

FIG. 3 is an example of a mobile computing device wherein one or more of the techniques of the disclosure may be implemented.

### DETAILED DESCRIPTION OF THE PRESENT DISCLOSURE

Waste disposal and collection is an important part of waste management. Embodiments of the present disclosure provide for efficient collection of waste at waste generator sites by using a user-facing service connected to a backend management system.

In some embodiments, the user facing service is a mobile device application (commonly referred to as an “app”), such as the Haulla app made by Ecube Labs. In some embodiments, the app is functionally connected to a platform, such as the Haulla platform made by Ecube Labs and comprising a Haulla platform server. In some embodiments, users of the Haulla app and Haulla platform comprise waste generators and waste haulers. Waste generators generate the waste that the haulers collect and dispose of In some embodiments, the platform is functionally connected to a fleet management system, such as the CCNx system made by Ecube Labs. The CCNx system can comprise a CCNx server that stores information and the CCNx fleet management software. In some embodiments, the users interact with the Haulla platform through the Haulla app, and the Haulla platform communicates with the CCNx fleet management software on the CCNx server.

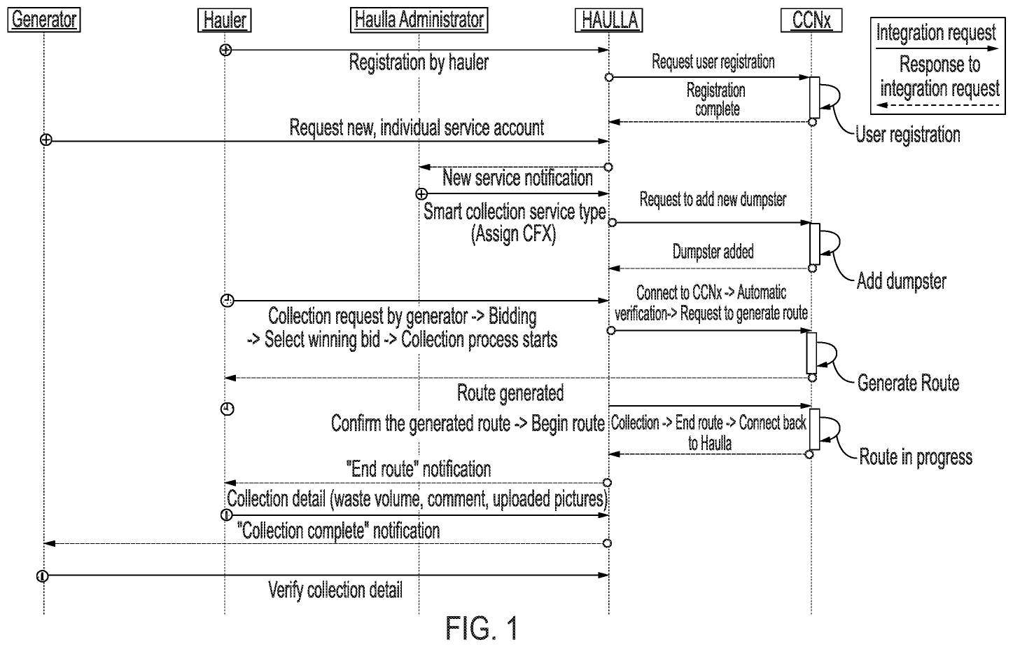

Referring now to FIG. 1, an example of a process for requesting waste collection services in accordance with the present disclosure is shown. In some embodiments, when a new hauler signs up to the Haulla platform, the hauler's information is first stored in a Haulla platform server. The same information is sent to and stored in the clean city network (CCNx) server, which in turn sends a signal back to the Haulla server indicating that the new hauler is registered. The hauler's information is therefore stored in both the Haulla platform and in the fleet management system.

In some embodiments, when a generator signs up for a collection service in the Haulla platform (e.g., Smart Collection service), a fill-level sensor (e.g., a CleanFLEX fill-level sensor available from Ecube Labs) is automatically assigned to the generator's service account. Then, the sensor is physically installed in the generator's waste container (e.g., a dumpster) related to the account. The fill-level sensor is operative to detect the fill-level of waste in the dumpster in which it is installed.

In some embodiments, once the physical sensor is installed, it begins to transmit data to the Haulla platform and/or to the fleet management system. For example, the fill-level sensor may transmit data wirelessly (for example, using wireless cellular communication). Such data transmission may include the dumpster's latitude and longitude, as well as the fill-level of the dumpster. In some embodiments, once the data is transmitted, the dumpster's latitude and longitude, and thus, the dumpster's exact location, is recorded in the CCNx server. A system status in the CCNx server and/or the Haulla platform can be generated, reflecting that the dumpster has been added to the system, and that the registration process is complete.

In some embodiments, when a hauler obtains the right to carry out a generator's collection request, but before the actual collection is made, the Haulla platform and/or the CCNx system go through a number of steps to dispatch a collection vehicle associated with the hauler and find the most optimal route for the vehicle to take. This process can be done via an integration of the Haulla platform and CCNx fleet management software.

In some embodiments, when the hauler indicates in their Haulla app that they are about to embark on the waste collection journey, the Haulla app connects to the CCNx fleet management system, and the connected CCNx is shown on the hauler's mobile device screen (e.g., by launching a CCNx app on the mobile device). In some embodiments, even if the Haulla user does not have a CCNx account, by connecting to CCNx via Haulla, the user can be automatically authenticated and logged into CCNx. CCNx can do this by matching the information of the Haulla user by dumpster name, email address, mobile number, and/or the latitude and longitude of the sensor (e.g., a CleanFLEX fill-level sensor) within the dumpster. Once in the CCNx system, the hauler can request that the fleet management system generate a route from the hauler's present location to the dumpster's location. The system can be designed to find the most optimal route for the hauler to take. The optimal route may be based on at least one factor, such as, e.g., the waste hauler's current location, the waste container's location, location of other waste container collection tasks, traffic, urgency of the collection task, and the like. In some embodiments, a route approximating the most optimal route is found.

In some embodiments, once the route is found, the hauler has access to the optimized route on their mobile device, at which point the vehicle can start the route. While the hauler is on the road, the location of the vehicle can be automatically updated in the system in relation to the collection point and displayed in the Haulla app. In some embodiments, both the hauler and the waste generator can observe the hauler's progress toward the dumpster by using the Haulla app. The location updating can occur continuously or at discrete intervals. It will be appreciated that the methods for updating the location can be designed similarly to those used by existing navigation applications.

In some embodiments, when the collection is completed, the hauler can input the volume and/or weight of the collected waste, comments specific to the particular collection point, and/or photos to provide verification that the collection has been made.

In some embodiments, when the CCNx system and/or the Haulla platform deems the collection completed, the CCNx app may become inactive in the back-end and the Haulla app can be reconnected. In some embodiments, the Haulla server can send a notification back to the hauler's mobile device to acknowledge that the collection has occurred. The system can also send a confirmation notification to the generator whose waste was collected. Once the confirmation has been received, both the generator and the hauler may browse through details regarding the collection that has taken place.

It will be appreciated that the various steps that are described as using user input can be made to occur automatically, such as via sensors that can automatically provide information to the app or learning algorithms that can predict the information that the user would input. It will also be appreciated that the division of tasks between the Haulla service and the CCNx service is described by way of example, and that in other embodiments of the present disclosure, the Haulla service and CCNx service can perform the tasks in a different configuration and division of labor, or all tasks may be performed by a single service. In yet another embodiment of the present disclosure, the platform system may be carried out in following steps: (1) subscribes/applies for service with Haulla system; (2) Register an individual service and set parameters unique to one's location (address, waste type, dumpster size, fill-level at which collection request is generated, etc.); (3) Haulers go through bidding process and the winning bidder is selected (4) Collection request is generated. The following steps are functionalities of the fleet management system which is now a built-in part of the platform system: (5) System automatically gathers collection points; (6) Collection vehicles are assigned to different collection points. The assignment of the collection vehicle can be automatic or manual in following steps: a. Automatic assignment of the vehicles means the following are set: i. Optimized collection routes; or ii. The order of collection points in a route. Then, the collection schedule is automatically generated and set and the driver of the collection vehicle is notified of the generated route and schedule. The route is then transmitted and used by the driver and then the collection takes place by the driver.

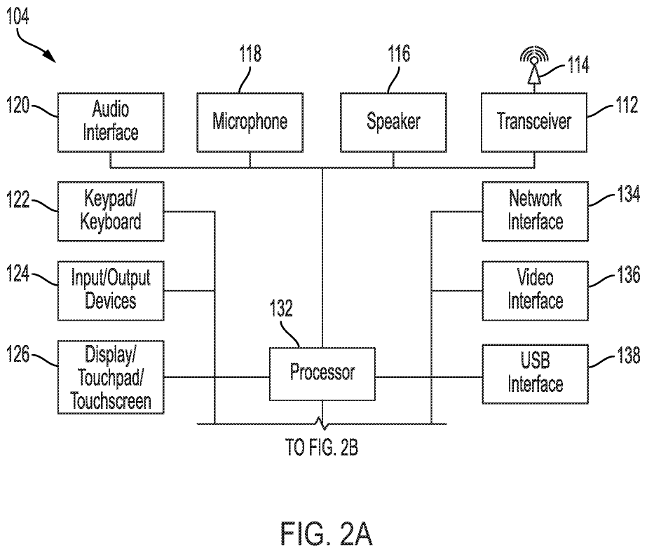

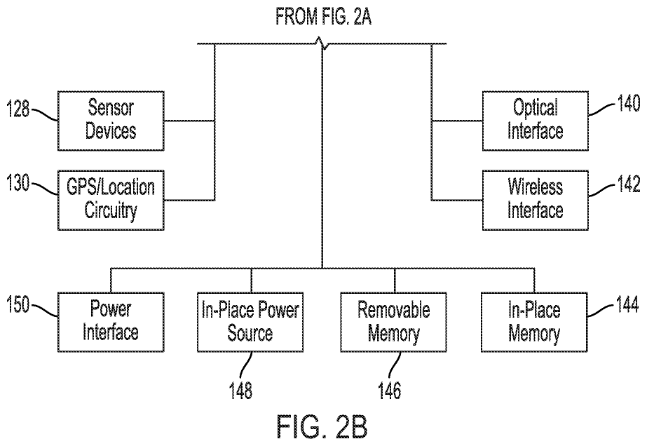

FIGS. 2A and 2B show a diagram of an example computer/computing (e.g., processing) device 104 that may implement one or more techniques described herein, in whole or at least in part, with respect to one or more of the devices, methods, and/or systems described herein. In FIGS. 2A and 2B, the computing device 104 may include one or more of: a processor 132, a transceiver 112, a transmit/receive element (e.g., antenna) 114, a speaker 116, a microphone 118, an audio interface (e.g., earphone interface and/or audio cable receptacle) 120, a keypad/keyboard 122, one or more input/output devices 124, a display/touchpad/touch screen 126, one or more sensor devices 128, Global Positioning System (GPS)/location circuitry 130, a network interface 134, a video interface 136, a Universal Serial Bus (USB) Interface 138, an optical interface 140, a wireless interface 142, in-place (e.g., non-removable) memory 144, removable memory 146, an in-place (e.g., removable or non-removable) power source 148, and/or a power interface 150 (e.g., power/data cable receptacle). The computing device 104 may include one or more, or any sub-combination, of the aforementioned elements.

The computing device 104 may take the form of a laptop computer, a desktop computer, a computer mainframe, a server, a terminal, a tablet, a smartphone, and/or a cloud-based computing device (e.g., at least partially), and/or the like.

The processor 132 may be a general-purpose processor, a special-purpose processor, a conventional processor, a digital-signal processor (DSP), a plurality of microprocessors, one or more microprocessors in association with a DSP core, a controller, a microcontroller, one or more Application Specific Integrated Circuits (ASICs), one or more Field Programmable Gate Array (FPGAs) circuits, any other type of integrated circuit (IC), and/or a finite-state machine, and/or the like. The processor 132 may perform signal coding, data processing, power control, sensor control, interface control, video control, audio control, input/output processing, and/or any other functionality that enables the computing device 104 to serve as and/or perform as (e.g., at least partially) one or more of the devices, methods, and/or systems disclosed herein.

The processor 132 may be connected to the transceiver 112, which may be connected to the transmit/receive element 124. The processor 132 and the transceiver 112 may operate as connected separate components (as shown). The processer 132 and the transceiver 112 may be integrated together in an electronic package or chip (not shown).

The transmit/receive element 114 may be configured to transmit signals to, and/or receive signals from, one or more wireless transmit/receive sources (not shown). For example, the transmit/receive element 114 may be an antenna configured to transmit and/or receive RF signals. The transmit/receive element 114 may be an emitter/detector configured to transmit and/or receive IR, UV, or visible light signals, for example. The transmit/receive element 114 may be configured to transmit and/or receive RF and/or light signals. The transmit/receive element 114 may be configured to transmit and/or receive signals in a cellular communications network. The transmit/receive element 114 may be configured to transmit and/or receive any combination of wireless signals.

Although the transmit/receive element 114 is shown as a single element, the computing device 104 may include any number of transmit/receive elements 114 (e.g., the same as for any of the elements 112-150). The computing device 104 may employ Multiple-Input and Multiple-Output (MIMO) technology. For example, the computing device 104 may include two or more transmit/receive elements 114 for transmitting and/or receiving wireless signals.

The transceiver 112 may be configured to modulate the signals that are to be transmitted by the transmit/receive element 114 and/or to demodulate the signals that are received by the transmit/receive element 114. The transceiver 112 may include multiple transceivers for enabling the computing device 104 to communicate via one or more, or multiple, radio access technologies, such as Universal Terrestrial Radio Access (UTRA), Evolved UTRA (E-UTRA), and/or IEEE 802.11, for example.

The processor 132 may be connected to, may receive user input data from, and/or may send (e.g., as output) user data to: the speaker 116, microphone 118, the keypad/keyboard 122, and/or the display/touchpad/touchscreen 126 (e.g., a liquid crystal display (LCD) display unit or organic light-emitting diode (OLED) display unit, among others). The processor 132 may retrieve information/data from and/or store information/data in, any type of suitable memory, such as the in-place memory 144 and/or the removable memory 146. The in-place memory 144 may include random-access memory (RAM), read-only memory (ROM), a register, cache memory, semiconductor memory devices, and/or a hard disk, and/or any other type of memory storage device.

The removable memory 146 may include a subscriber identity module (SIM) card, a portable hard drive, a memory stick, and/or a secure digital (SD) memory card, and/or the like. The processor 132 may retrieve information/data from, and/or store information/data in, memory that might not be physically located on the computing device 104, such as on a server, the cloud, and/or a home computer (not shown).

One or more of the elements 112-146 may receive power from the in-place power source 148. In-place power source 148 may be configured to distribute and/or control the power to one or more of the elements 112-146 of the computing device 104. The in-place power source 148 may be any suitable device for powering the computing device 104. For example, the in-place power source 148 may include one or more dry cell batteries (e.g., nickel-cadmium (NiCd), nickel-zinc (NiZn), nickel metal hydride (NiMH), lithium-ion (Li-ion), etc.), solar cells, and/or fuel cells, and/or the like.

Power interface 150 may include a receptacle and/or a power adapter (e.g., transformer, regulator, and/or rectifier) that may receive externally sourced power via one or more AC and/or DC power cables, and/or via wireless power transmission. Any power received via power interface 150 may energize one or more of the elements 112-146 of computing device 104, perhaps for example exclusively or in parallel with in-place power source 148. Any power received via power interface 150 may be used to charge in-place power source 148.

The processor 132 may be connected to the GPS/location circuitry 130, which may be configured to provide location information (e.g., longitude and/or latitude) regarding the current location of the computing device 104. The computing device 104 may acquire location information by way of any suitable location-determination technique.

The processor 132 may be connected to the one or more input/output devices 124, which may include one or more software and/or hardware modules that provide additional features, functionality and/or wired and/or wireless connectivity. For example, the one or more input/output devices 124 may include a digital camera (e.g., for photographs and/or video), a hands free headset, a digital music player, a media player, a frequency modulated (FM) radio unit, an Internet browser, and/or a video game player module, and/or the like.

The processor 132 may be connected to the one or more sensor devices 128, which may include one or more software and/or hardware modules that provide additional features, functionality and/or wired and/or wireless connectivity. For example, the one or more sensor devices 128 may include a CleanFLEX fill-level sensor, an accelerometer, an e-compass, and/or a vibration device, and/or the like.

The processor 132 may be connected to the network interface 134, which may include one or more software and/or hardware modules that provide additional features, functionality and/or wireless and/or wired connectivity. For example, the network interface 134 may include a Network Interface Controller (NIC) module, a Local Area Network (LAN) module, an Ethernet module, a Physical Network Interface (PNI) module, and/or an IEEE 802 module, and/or the like.

The processor 132 may be connected to the video interface 136, which may include one or more software and/or hardware modules that provide additional features, functionality and/or wired and/or wireless connectivity. For example, the video interface 136 may include a High-Definition Multimedia Interface (HDMI) module, a Digital Visual Interface (DVI) module, a Super Video Graphics Array (SVGA) module, and/or a Video Graphics Array (VGA) module, and/or the like.

The processor 132 may be connected to the USB interface 138, which may include one or more software and/or hardware modules that provide additional features, functionality and/or wired and/or wireless connectivity. For example, the USB interface 138 may include a universal serial bus (USB) port, and/or the like.

The processor 132 may be connected to the optical interface 140, which may include one or more software and/or hardware modules that provide additional features, functionality and/or wired and/or wireless connectivity. For example, the optical interface 140 may include a read/write Compact Disc module, a read/write Digital Versatile Disc (DVD) module, and/or a read/write Blu-ray™ disc module, and/or the like.

The processor 132 may be connected to the wireless interface 142, which may include one or more software and/or hardware modules that provide additional features, functionality and/or wireless connectivity. For example, the wireless interface 142 may include a Bluetooth® module, an Ultra-Wideband (UWB) module, a ZigBee module, and/or a Wi-Fi (IEEE 802.11) module, and/or the like.

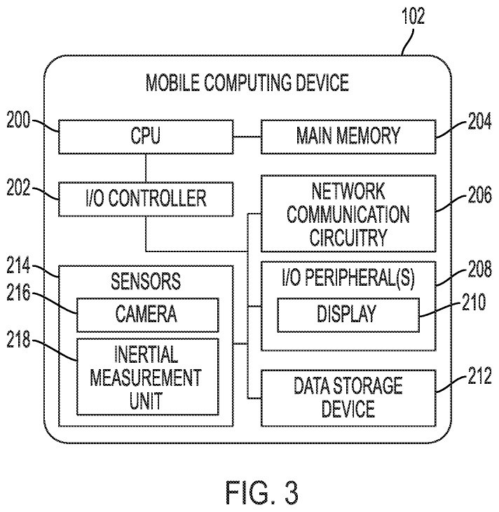

Referring now to FIG. 3, the illustrative example of a mobile computing device that is constructed in accordance with the principles of the present disclosure. The mobile computing device 102, which may host any of the apps or other software disclosed herein, includes a central processing unit (CPU) 200, an input/output (I/O) controller 202, a memory 204, network communication circuitry 206, one or more I/O peripherals 208, a data storage device 212, and/or various sensors 214. In some scenarios, there may be additional, fewer, and/or alternative components to those of the illustrative mobile computing device 102, such as a graphics processing unit (GPU). In some scenarios, one or more components may be combined on a single system-on-a-chip (SoC) on a single integrated circuit (IC). In some scenarios, the type of components of the respective mobile computing device 102 may be predicated upon the type and/or intended use of the respective mobile computing device 102.

The illustrative mobile computing device 102 includes an application, such as any of the apps disclosed herein. The application of the mobile computing device 102 is executed by mobile computing device 102 to carry out the functions allocated to mobile computing device 102 according to the present disclosure. The application may be embodied as any combination of hardware, firmware, software, and/or circuitry usable to perform the functions described herein.

The CPU 200, or processor, may be embodied as any combination of hardware and/or circuitry capable of processing data. In some scenarios, the mobile computing device 102 may include more than one CPU 200. Perhaps depending on the scenario, the CPU 200 may include one processing core (not shown), such as in a single-core processor architecture, or multiple processing cores, such as in a multi-core processor architecture. Irrespective of the number of processing cores and/or CPUs 200, the CPU 200 is capable of reading and/or executing program instructions. In some scenarios, the CPU 200 may include cache memory (not shown) that may be integrated directly with the CPU 200 or placed on a separate chip with a separate interconnect to the CPU 200. In some scenarios, pipeline logic may be used to perform software and/or hardware operations (e.g., network traffic processing operations), rather than commands issued to/from the CPU 200.

The I/O controller 202, or I/O interface, may be embodied as any type of computer hardware and/or combination of circuitry capable of interfacing between input/output devices and/or the mobile computing device 102. Illustratively, the I/O controller 202 may be configured to receive input/output requests from the CPU 200, and/or send control signals to the respective input/output devices, thereby managing the data flow to/from the mobile computing device 102.

The memory 204 may be embodied as any type of computer hardware and/or combination of circuitry capable of holding data and/or instructions for processing. Such memory 204 may be referred to as main or primary memory. In some scenarios, one or more components of the mobile computing device 102 may have direct access to memory, such that certain data may be stored via direct memory access (DMA) independently of the CPU 200.

The network communication circuitry 206 may be embodied as any type of computer hardware and/or combination of circuitry capable of managing network interfacing communications (e.g., messages, datagrams, packets, etc.) via wireless and/or wired communication modes. In some scenarios, the network communication circuitry 206 may include a network interface controller (NIC) capable of being configured to connect the mobile computing device 102 to a computer network, as well as other devices, perhaps for example depending on the scenario.

The one or more I/O peripherals 208 may be embodied as any auxiliary device configured to connect to and/or communicate with the mobile computing device 102. For example, the I/O peripherals 208 may include, but are not limited to, a mouse, a keyboard, a monitor, a touchscreen, a printer, a scanner, a microphone, a speaker, etc. Some I/O devices may be capable of one function (e.g., input or output), or both functions (e.g., input and/or output. The illustrative I/O peripherals 208 includes a display, which may be embodied as a touchscreen display capable of receiving user input via touch (e.g., one or more fingers, a stylus, etc.).

In some scenarios, the I/O peripherals 208 may be connected to the mobile computing device 102 via a cable (e.g., a ribbon cable, a wire, a universal serial bus (USB) cable, a high-definition multimedia interface (HDMI) cable, etc.) of the mobile computing device 102. In some scenarios, the cable may be connected to a corresponding port (not shown) of the mobile computing device 102 for which the communications made there between can be managed by the I/O controller 202. In some scenarios, the I/O peripherals 208 may be connected to the mobile computing device 102 via a wireless mode of communication (e.g., Bluetooth®, Wi-Fi®, etc.) which can be managed by the network communication circuitry 206.

The data storage device 212 may be embodied as any type of computer hardware capable of the non-volatile storage of data (e.g., semiconductor storage media, magnetic storage media, optical storage media, etc.). Such data storage devices 212 are commonly referred to as auxiliary and/or secondary storage, and/or may be used to store a large amount of data relative to the memory 204 described above.

The illustrative sensors 214 include a camera sensor 216 and/or an inertial measurement unit (IMU) sensor 218. In some scenarios, the sensors 214 may include one or more additional sensors 214. The camera sensor 216 may be embodied as an type of image sensor (e.g., complementary metal-oxide-semiconductor (CMOS), charge-coupled device (CCD), hybrid CCD/CMOS, etc.) capable of capturing different types of scene data, such as color image data (RGB), color and depth image data (RGBD camera), depth sensor, stereo camera (L/R RGB), YUV, GRAY scale, and/or any other image sensor technology that can generate digital image frames.

The IMU sensor 218 may include one or more software and/or hardware gyroscopes to measure the orientation of the mobile computing device 102 (e.g., a 3-axis gyroscope), accelerometers to measure proper acceleration of the mobile computing device 102 (e.g., a 3-axis accelerometer), magnetometers to measure the direction of the Earth's magnetic field relative to the mobile computing device 102 (e.g., a 3-axis magnetometer), and/or any other type of inertial motion measurement software/hardware usable to perform the functions described herein (e.g., measure motion along three perpendicular linear axes and/or the rotation around, one or more, or each, of the three perpendicular linear axes).

The network 102 may be implemented as any type of wired and/or wireless network, including a local area network (LAN), a wide area network (WAN), a global network (the Internet), etc. Accordingly, the network 102 may include one or more communicatively coupled network computing devices (not shown) for facilitating the flow and/or processing of network communication traffic via a series of wired and/or wireless interconnects. Such network computing devices may include, but are not limited to, one or more access points, routers, switches, servers, computer devices, storage devices, etc. [0053] The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A system for managing collection, by a waste hauler, of waste generated by a waste generator at a waste generator site, the system comprising:
a user interface;
a platform system functionally connected to the user interface;
a fleet management system functionally connected to the platform system;
a waste container at the waste generator site;
a sensing device operative to sense a fill-level of the waste container;
wherein the user interface is operable to allow the waste hauler to connect to the platform system and to the fleet management system to arrange a waste collection at the waste generator site based at least on the sensing device at the waste generator site indicating a fill-level of the waste container is equal to or more than a predetermine waste level.

2. The system of claim 1, where the user interface is a mobile device application.

3. The system of claim 2, wherein the mobile device application is functionally connected to the platform system.

4. The system of claim 1, wherein the fleet management system comprises a server that stores information and a fleet management process.

5. The system of claim 1, wherein:
the user interface is operable to allow the waste hauler to transmit information to the platform system to create an account, the information being stored in the platform system;
the platform system sends the information to the fleet management system and the fleet management system stores the information; and
the fleet management system sends a signal back to the platform system indicating that the waste hauler is registered.

6. The system of claim 1, wherein user interface is operable to allow the waste generator to sign up for a waste collection service via the controller system, and the platform system automatically assigns the sensing device to a service account associated with the waste generator.

7. The system of claim 1, where the sensing device is a fill-level sensor, and the fill-level sensor is physically installed inside of the waste container.

8. The system of claim 1, wherein the sensor transmits a plurality of data, the plurality of data comprises the waste container's latitude and longitude, which specifies an exact location of the waste container, and the exact location of the waste container is stored in the fleet management system.

9. The system of claim 8, wherein the plurality of data is transmitted wirelessly.

10. The system of claim 1, wherein the user interface is operable by the waste hauler to indicate to the platform system an intention to perform the waste collection, the platform system functionally connects to the fleet management system, and the fleet management system generates a route from the waste hauler's current location to the waste container's location.

11. The system of claim 10, wherein the route is a most optimal route based on the waste hauler's current location and the waste container's location.

12. The system of claim 10, wherein the route is displayed on the user interface.

13. The system of claim 12, wherein a current location of the waste hauler is displayed on the user interface in relation to the waste container's location.

14. The system of claim 13, wherein the current location of the waste hauler is updated on the user interface at discrete intervals.

15. The system of claim 1, wherein the waste container comprises a dumpster.

16. The system of claim 1, wherein after the waste collection is complete, the waste hauler may use the user interface to transmit information to the platform system, the information selected from the group consisting of: a volume of the collected waste, a weight of the collected waste, a comment specific to the waste collection, and a photo to provide verification that the waste collection has occurred.

17. The system of claim 1, wherein when the fleet management system deems a waste collection completed, the fleet management system stays connected to the user interface.

18. The system of claim 1, wherein the platform system is configured to send a notification back to the waste hauler via the user interface to acknowledge the waste collection has occurred.

19. The system of claim 1, wherein the platform system transmits a confirmation notification to the waste generator acknowledging the waste collection has been completed.

20. The system of claim 18, wherein once the confirmation notification has been transmitted, both the waste generator and the waste hauler may use the user interface to review a plurality of details regarding the waste collection.
